(19) United States
(12) Patent Application Publication
(10) Pub. No.: US 2017/0211344 A1
(43) Pub. Date: Jul. 27, 2017

(54) METHOD FOR OPERATING A TONGS SYSTEM FOR USE ON A RIG AND CORRESPONDING TONGS SYSTEM, COMPUTER PROGRAM FOR IMPLEMENTING THE METHOD AND RIG COMPRISING A TONGS SYSTEM

(71) Applicant: Bentec GmbH Drilling & Oilfield Systems, Bad Bentheim (DE)

(72) Inventors: Jan AALDERINK, Bad Bentheim (DE); Andre REUTER, Gronau-Epe (DE); Malte CORDES, Rheine (DE)

(21) Appl. No.: 15/316,507

(22) PCT Filed: May 29, 2015
(86) PCT No.: PCT/EP2015/061924

§ 371 Date: Apr. 17, 2017

(30) Foreign Application Priority Data
Jun. 6, 2014 (DE) 10 2014 210 860.8

(51) Int. Cl. E21B 19/16; G01L 5/24; E21B 17/042

(52) U.S. Cl. CPC E21B 19/166; E21B 19/163; E21B 17/042; G01L 5/24

(57) ABSTRACT

The invention relates to a method for operating a tongs system (10) designed for assembling a drill string element (12) and an often stationary drill string element (12) or for separating a drill string element (12) from another drill string element (12), said tongs system having lower tongs and upper tongs that can be moved relative to the lower tongs by means of a drive unit (18). A displacement-measuring system (44) detects a position (46) of the upper tongs relative to the lower tongs. A control unit (48) compares an application torque determined as a function of the detected position (46) with a defined or definable desired application torque (54). The assembly of the two drill string elements (12) is terminated when the determined application torque reaches or exceeds the desired application torque (54). The invention also relates to a tongs system (I 0) operating according to said method.

### FIELD OF THE INVENTION

The invention relates first and foremost to a method for operating a tongs system for use on a rig for deep wells, e.g. for sinking wells in hydrocarbon deposits for crude oil and natural gas exploration or for exploiting geothermal energy, which system is often also referred to in the specialist jargon as a “floorhand” or “iron roughneck” and can also be designated as an automatic rod clamp. The invention also relates to a tongs system for carrying out the method and for use in accordance with the method.

### DESCRIPTION OF THE RELATED ART

A tongs system of this kind is described in US 2007/068669 A.

A tongs system of the type in question is provided for the purpose of connecting two drill pipe elements or for separating two drill pipe elements, in particular for connecting a drill pipe element to the drill string or for releasing a drill pipe element from the drill string during the installation and removal of the drill pipe. For this purpose, the tongs system is moved by means of a movable arm or the like into a region above the borehole or a region above the “mouse hole”. There, a drill pipe element is connected to a fixed drill pipe element by initially connecting the threads of the two drill pipe elements (“spinning”) and then tightening the threaded joint (“torqueing”) or a drill pipe element is separated from a fixed drill pipe element. The fixed drill pipe element is fixed as a component part of the drill string or by virtue of its placement in the mouse hole, for example. To make it easier to read—but without sacrificing wider applicability—the following description is continued in relation to a fixed drill pipe element as a component part of the drill string and in relation to use of the tongs system above the borehole. The description applies equally to a drill pipe element, the fixed position of which is the result of its placement in the mouse hole, and use of the tongs system above the mouse hole should be understood as correspondingly implicit in every mention of use of the tongs system above the borehole. In principle, a tongs system of the type proposed here can also be used at other points in a rig and, in general, for any use in connecting or separating a threaded joint between two elements having a round cross section, at least in sections.

By means of lower tongs included in the tongs system, the tongs system is first of all fixed on the fixed drill pipe element in a manner known per se. By means of upper tongs, which can be moved relative to the lower tongs, either a further drill pipe element is then connected to the fixed drill pipe element or a drill pipe element is then released from the fixed drill pipe element, likewise in a manner known per se.

Specifically when connecting a further drill pipe element to the fixed drill pipe element, it is important to achieve and maintain a defined or definable tightening torque. The load bearing capacity of the drill string during drilling depends on the correct tightening torque. However, maintaining a defined or definable tightening torque is not a simple matter if a torque that can be exerted by means of a drive unit varies during the connection or separation of two drill pipe elements.

U.S. Pat. No. 6,752,044 B discloses a tongs system in which at least one tongs is rotated by means of an actuator in the form of a hydraulic or pneumatic cylinder in order to connect or release drill pipe elements. To obtain the respectively required torque, there is the possibility of fixing the actuator in different positions of a lever. A lever arm length and a torque correlated therewith for connecting or separating drill pipe elements is obtained depending on the selected position. US 2014/0116687 A discloses a tongs system in which at least one tongs is rotated by means of a motor acting on a ring. The radius of the ring can be understood as the effective length of a lever arm. This does not change during operation. Consequently, a torque that can be applied by means of the motor and of the ring is also constant during the connection or separation of two drill pipe elements. In EP 0 138 472 B too, a drill pipe element is moved by means of a turntable relative to a drill pipe element fixed against rotation. While the turntable is being driven, the torque that can be applied during the connection or separation of two drill pipe elements is likewise constant.

### SUMMARY OF THE INVENTION

One object of the present invention is to specify a method for operating a tongs system of the type stated at the outset by means of which it is possible to reach and maintain a defined or definable tightening torque reliably and efficiently, even when a torque that can be exerted during the connection or separation of two drill pipe elements is not constant. It is a further object of the invention to specify a tongs system suitable for carrying out the method.

According to the invention, the object mentioned first above is achieved by means of a method for operating a tongs system of the type stated at the outset having the features of claim 1. For this purpose, the following is provided in a method for operating a tongs system intended for connecting a drill pipe element to a fixed drill pipe element, that is to say a tongs system which comprises lower tongs and upper tongs, which can be moved relative to the lower tongs, in particular in rotation, by means of a drive unit: the tongs system comprises a displacement measuring system, or a displacement measuring system is assigned to the tongs system. The tongs system furthermore comprises a control unit, or a control unit is assigned to the tongs system. By means of the displacement measuring system, a position of the upper tongs relative to the lower tongs can be detected directly or indirectly, and such a position is detected in operation by means of the displacement measuring system. By means of the control unit, a respective tightening torque acting during the connection of the drill pipe elements is determined continuously or at regular intervals and in accordance with the detected position and is compared with a defined or definable desired tightening torque. The connection of the two drill pipe elements is terminated automatically by means of the control unit when the determined tightening torque reaches or exceeds the desired tightening torque.

The advantage of the concept proposed here is especially that the threaded sections of the two drill pipe elements are connected with a defined tightening torque and that it is ensured that, on the one hand, the tightening torque is reliably achieved, i.e. an associated strength of the threaded joint is provided, and that, on the other hand, the tightening torque is also not exceeded or at least not significantly exceeded, with the result that there is no unnecessary wear of the threaded sections of the two drill pipe elements.

The advantage of the innovation proposed here furthermore consists in that the defined tightening torque is achieved even though a torque that can be exerted by means of a drive unit during the connection of two drill pipe elements varies. To achieve this, the respective tightening torque acting during the connection of the two drill pipe elements is determined in accordance with the position of the upper tongs relative to the lower tongs and is compared with the defined tightening torque to be achieved. Such determination of a respectively acting tightening torque and such comparisons are not necessary in the methods according to US 2014/0116687 A and EP 0 138 472 B because the tightening torque that can be applied there is independent of a position of the respective tongs and hence does not vary.

Advantageous embodiments of the invention are the subject matter of the dependent claims. Dependency references used therein indicate the development of the subject matter of the main claim by the features of the respective dependent claims. They should not be interpreted as sacrificing the achievement of independent substantive protection for the combination of features in the dependent claims containing the dependency reference. Moreover, in respect of the interpretation of the claims when there is a more specific definition of the feature in a subsequent claim, it can be assumed that there is no such restriction in the respectively preceding claims.

In one embodiment of the method, the tightening torque is determined automatically by means of the control unit in accordance with the detected position and in accordance with a measure of a force exerted by the drive unit. Here, the measure of the force exerted by the drive unit is recorded in relation to a drive unit specified for moving the upper tongs, e.g. by recording a measured value suitable as a measure of the exerted force at the drive unit. In the case of a hydraulic cylinder acting as a drive unit, a pressure acting in the hydraulic cylinder during the movement of the upper tongs is detected by means of a pressure sensor assigned to the hydraulic cylinder as a measure of the force exerted by means of the drive unit.

In another embodiment of the method, the upper tongs are moved at a (high) initial speed at the beginning of the connection of the two drill pipe elements, and the speed at which the upper tongs are moved is reduced, starting from the initial speed, in accordance with a countertorque that builds up during the connection of the two drill pipe elements, in particular being reduced continuously or reduced in stages. This leads to a particularly quick connection of the two drill pipe elements in that the upper tongs are initially moved at the high initial speed, and the speed is reduced only when the threaded joint becomes tight or begins to be tight. In comparison with an otherwise conventional constant speed of movement of the upper tongs relative to the lower tongs, it is possible in this way to significantly reduce the time required to connect two drill pipe elements. In the case of successive installation of a multiplicity of drill pipe elements, the time saving is multiplied to give a quite significant amount, depending on the total length of the resulting drill string. Moreover, reducing the speed in accordance with the countertorque allows particularly accurate achievement of the defined desired tightening torque.

In a specific embodiment of such a method, in which the speed is reduced, starting from the initial speed, in accordance with the countertorque and in which a hydraulic cylinder acts as the drive unit for moving the upper tongs, the pressure acting in the hydraulic cylinder during the movement of the upper tongs is used as a measure for the countertorque that builds up during the connection of the two drill pipe elements. This pressure can be detected in a comparatively simple manner by means of a suitable sensor system, e.g. a pressure cell or the like. By means of an electronically processable measured value for this pressure and by means of the piston or ring area in the hydraulic cylinder, which is likewise known because the dimensions of the hydraulic cylinder are known, it is possible to determine the respectively acting force directly as the product of the measured pressure value and the area acted upon by the pressure. The countertorque is then obtained as the product of the respectively acting force and an effective lever arm determined in accordance with the detected position of the upper tongs relative to the lower tongs, which product can likewise be determined by means of the control unit.

In another embodiment of the method of the type described here and below, which is provided not only for connecting two drill pipe elements but also for releasing a drill pipe element from a fixed drill pipe element, with reference to a respective position of the upper tongs relative to the lower tongs, said position being detected by the displacement measuring system, the upper tongs are moved into a position in which a maximum torque can be exerted before the beginning of release of the connection of the two drill pipe elements. In this way, the position of the upper tongs relative to the lower tongs, which is detectable by means of the displacement measuring system, is used not only to limit the tightening torque to the desired tightening torque, and reliably to achieve said torque, during the connection of two drill pipe elements but also to optimally position the upper tongs during the release of the threaded joint of two drill pipe elements.

The method and individual embodiments of the method are implemented by means of a control unit and of a control program executed by the control unit, namely by a microprocessor or the like included in the control unit. The abovementioned object is thus also achieved with such a control unit and actuators and sensors associated with the control unit, namely, for example, with a control block inserted ahead of the hydraulic cylinder and with a pressure cell assigned to the hydraulic cylinder. Thus, the invention is at least partially implemented in software. The invention is thus, on the one hand, also a computer program in the form of the control program executed by the control unit, comprising program code instructions that can be executed by a computer, and, on the other hand, a storage medium containing a computer program of this kind, i.e. a computer program product comprising program code means, and finally also a control unit, in the memory of which such a computer program is loaded or can be loaded as a means for carrying out the method and embodiments thereof. Insofar as the abovementioned object is achieved by a tongs system intended and designed for carrying out the method and individual embodiments of the method, the control unit with the control program loaded into the memory of the control unit is a means for carrying out the method which is included in the tongs system or associated with the tongs system.

In one embodiment of the tongs system, the displacement measuring system is associated with a drive unit provided for moving the upper tongs relative to the lower tongs, e.g. a hydraulic cylinder acting as a drive unit. An incremental encoder or the like, for example, may be considered as a displacement measuring system or sensor system in a displacement measuring system of this kind. In principle, as an alternative or in addition, consideration may also be given to assigning the displacement measuring system to the lower tongs or the upper tongs and determining the position, in particular the rotational position, of the upper tongs relative to the lower tongs directly. However, assigning the displacement measuring system to the drive unit is regarded as advantageous because—unlike with assignment of the displacement measuring system to the upper or lower tongs—there is less risk of contamination and damage in this region.

### BRIEF DESCRIPTION OF THE DRAWINGS

An illustrative embodiment of the invention is explained in greater detail below with reference to the drawing. Mutually corresponding objects or elements are provided with the same reference signs in all the figures. The illustrative embodiment should not be interpreted as restricting the invention. On the contrary, changes and modifications are also possible within the scope of the present disclosure, and a person skilled in the art seeking to achieve the object can derive these, for example, by combining or modifying individual features or method steps described in connection with the general or specific parts of the description and contained in the claims and/or the drawing, leading, through the possibility of combining features, to novel subject matter or novel method steps or sequences of method steps, insofar also as they relate to working methods.

In the drawing:

FIG. 1, FIG. 2 and FIG. 3 show an embodiment of a specific tongs system for connecting and separating two drill pipe elements,

FIG. 4 shows snapshots of the connection of two drill pipe elements,

FIG. 5 shows snapshots of the operation of the tongs system,

FIG. 6 and FIG. 7 show the tongs system or parts of the tongs system together with a control unit intended for controlling the tongs system, and

FIG. 8 shows the dependence of a manipulated variable generated by the control unit on a pressure which is established during the operation of the tongs system.

### DETAILED DESCRIPTION OF ILLUSTRATED EMBODIMENTS

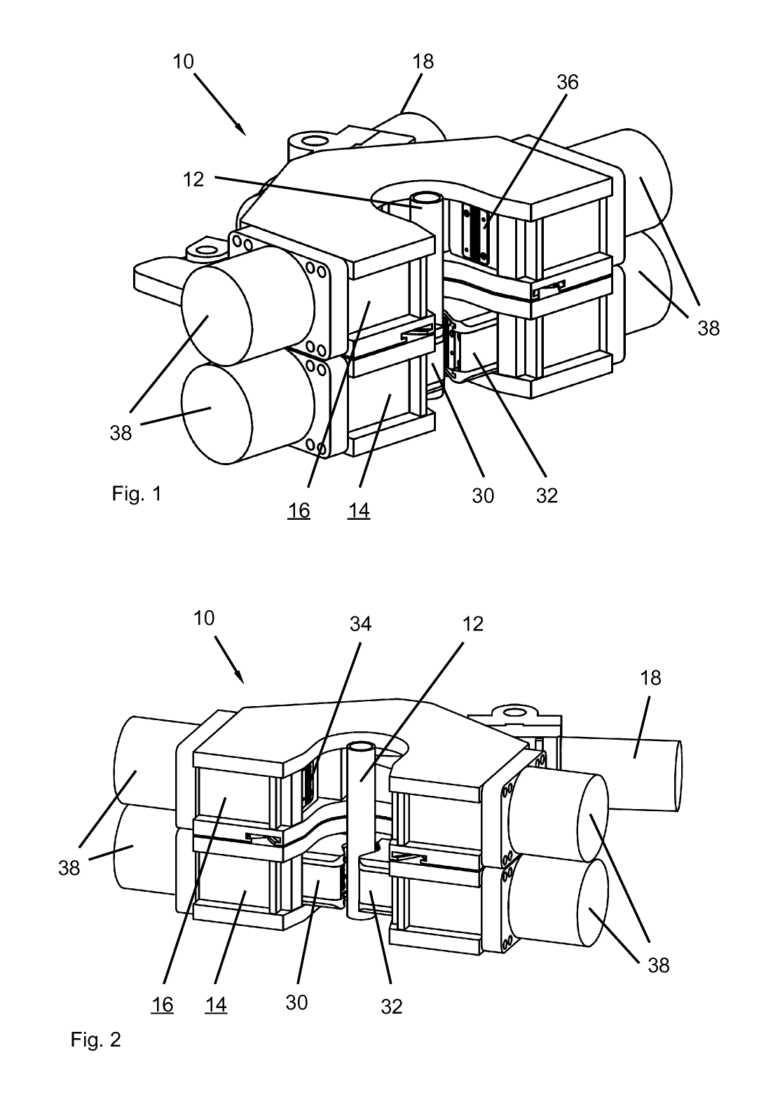

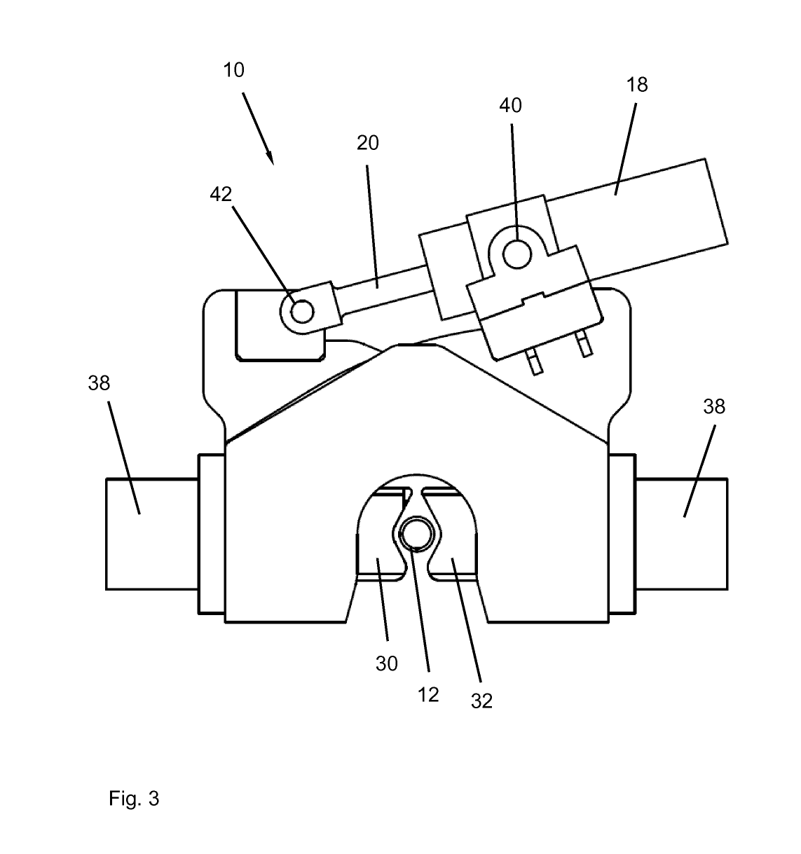

The illustrations in FIG. 1 and FIG. 2 show isometric views of one embodiment of a specific tongs system 10 from different directions of view, said system being intended for use on the “drill floor” of a rig, known per se but not itself shown, intended for sinking wells in hydrocarbon deposits for crude oil and natural gas exploration or for exploiting geothermal energy. The illustration in FIG. 3 shows the tongs system 10 according to FIG. 1 and FIG. 2 in a plan view.

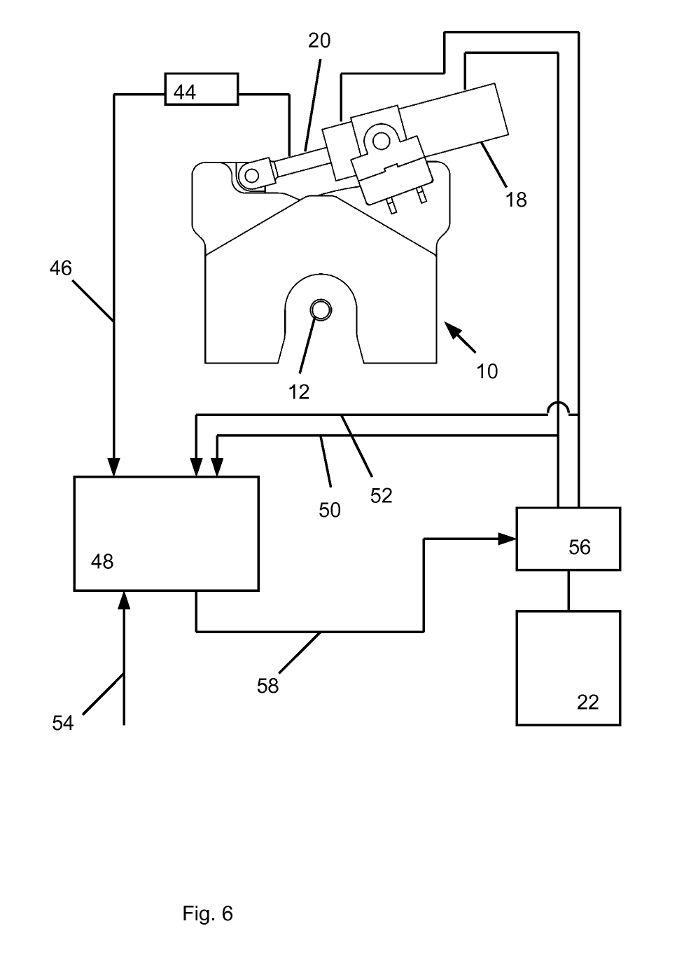

The tongs system 10 comprises lower tongs 14 and upper tongs 16. The two tongs 14, 16 can be moved in rotation relative to one another by means of a drive unit 18, here shown as a hydraulic cylinder, allowing a drill pipe element 12 to be released from the drill string or a drill pipe element 12 to be connected to the drill string by means of the tongs system 10. For this purpose, the drive unit 18 is connected non-rotatably to the lower tongs 14, and a piston rod 20 (FIG. 3) that can be moved with the drive unit 18 engages on the upper tongs 16. Retraction and extension of the piston rod 20 by pressurization of the piston of the piston rod 20 by means of a hydraulic unit 22 (FIG. 6) accordingly leads to rotation of the upper tongs 16 relative to the lower tongs 14. Instead of a hydraulic cylinder acting as a drive unit 18, a leadscrew or the like driven by electric motor, for example, may also be taken into consideration.

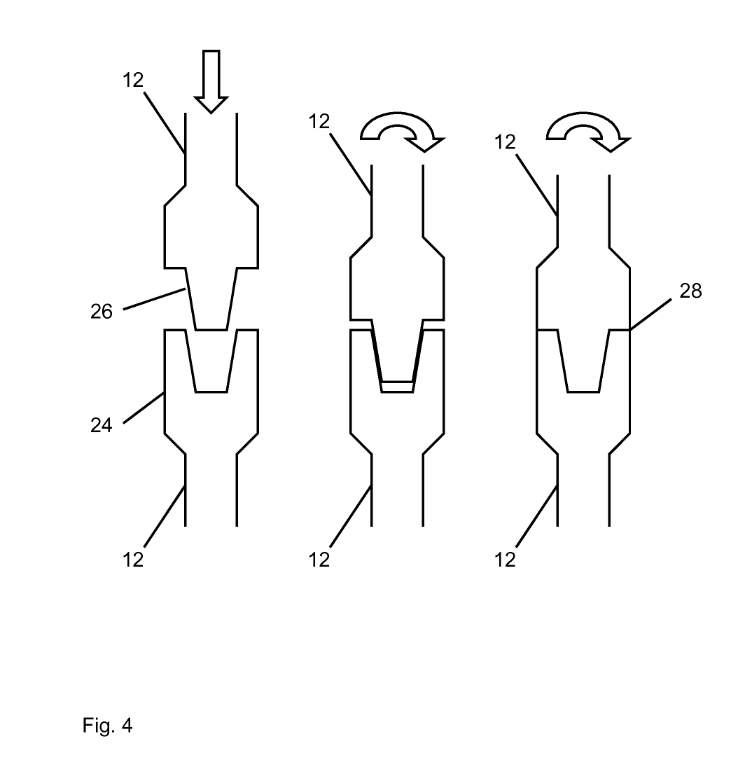

The tongs system 10 is part of a device referred to in the usual specialist jargon as a “floorhand” or “iron roughneck”, for example. A device of this kind overall, and specifically the tongs system 10, are used, when installing and removing drill pipe elements 12, for screwing a drill pipe element 12 to the drill string or for releasing a drill pipe element 12 from the drill string, among other operations. During installation, the drill pipe elements 12 are connected in a manner known per se by screwing, as shown in a schematically simplified form by means of the illustrations in FIG. 4. It shows respectively an upper section of a fixed drill pipe element 12 and a lower section of another drill pipe element 12, which is to be connected thereto. From left to right, it shows that the two drill pipe elements 12 are first of all positioned in axial alignment (left-hand illustration), that initial connection of the threads of the two drill pipe elements 12 then takes place (central illustration)—by means of a device usually referred to as a “spinner”, which is combined with the tongs system 10—and, finally, the threaded joint is tightened (right-hand illustration)—by means of the tongs system 10 (not shown in FIG. 3).

For this purpose, in a manner known per se, each drill pipe element 12 has, at one end, a sleeve 24, also referred to in the specialist jargon as a “box”, having an internal thread and, at the other end, a threaded spigot 26, also referred to as a “pin” in the specialist jargon, which can be screwed into a sleeve 24 of this kind and into the internal thread situated there. In the specialist jargon, the connection point is also referred to as a tool joint 28.

In each case, the lower tongs 14 engage below the tool joint 28 and, at the same time, grip the drill pipe element 12 which forms the upper end of the drill string and hence the fixed drill pipe element 12. The upper tongs 16 engage above the tool joint 28 and, accordingly, grip the drill pipe element 12 which is being released from the drill string or being connected to the drill string. For this purpose and in order to transmit the force required in actuating the threaded joint, the tongs system 10 has four clamping blocks 30, 32, 34, 36, namely two mutually facing/mutually opposite clamping blocks 30, 32 in the lower tongs 14 and two mutually facing/mutually opposite clamping blocks 34, 36 in the upper tongs 16. The translational movement of each clamping block 30-36 is accomplished by means of a drive unit 38, which is likewise shown here as a hydraulic cylinder.

During the connection of a new drill pipe element 12 to the drill string (FIG. 3, right-hand illustration) by tightening the threaded joint of the two drill string elements 12—the following explanation is continued using the connection of a drill pipe element 12 to the drill string as an example; the release of a drill pipe element 12 from the drill string is performed similarly in a reverse sequence—the upper tongs 16 are moved relative to the lower tongs 14, namely rotated or rotated in steps. During the connection of the new drill pipe element 12 to the drill string, the lower tongs 14 engaging on the drill string remain in contact with the drill pipe element 12 forming the upper end of the drill string.

It is assumed here that initial threading of the threaded spigot 26 of the new drill pipe element 12 into the internal thread of the sleeve 24 of the drill pipe element 12 which forms the upper end of the drill string has taken place before such tightening of the threaded joint. This threading is accomplished by means of the “spinner” already mentioned and, by means of the spinner, the new drill pipe element 12 is set in rapid rotation (“spinning”) and, in this way, the two drill pipe elements 12 and the threaded parts 24, 26 thereof in each case come into contact in such a way that a “shoulder” on the lower end of the threaded spigot 26 comes to rest on a shoulder at the upper end of the sleeve 24 without the threaded joint already having been tightened. Tightening of the threaded joint is accomplished by means of the relative movement of the upper tongs 16 and the lower tongs 14, and the method described here and below is performed after spinning.

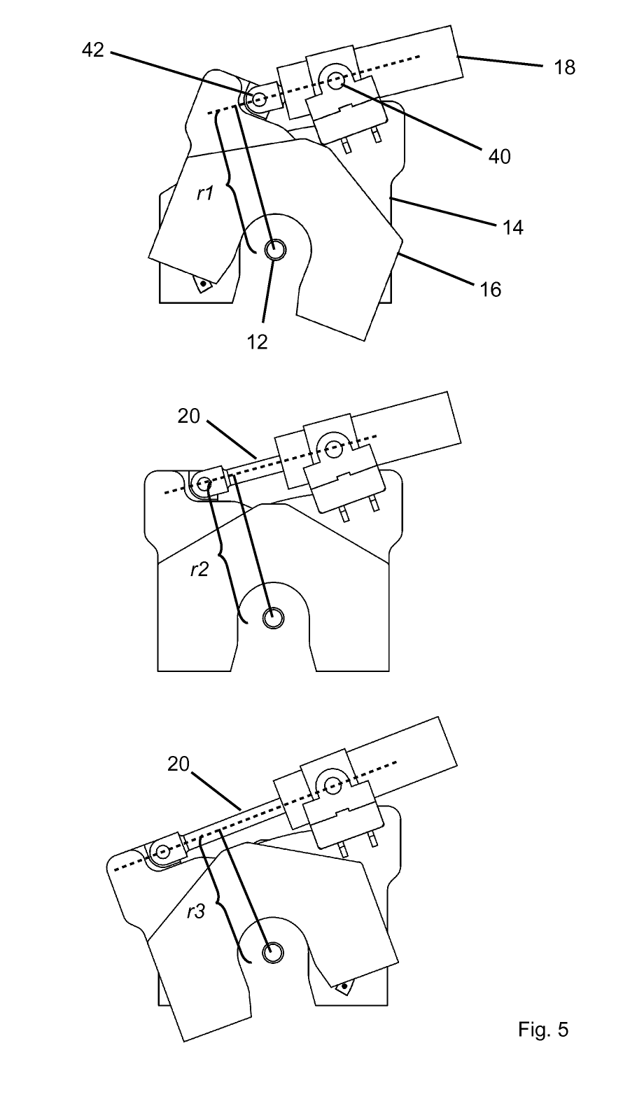

During the tightening of the threaded joint and during rotation of the upper tongs 16 relative to the lower tongs 14, a torque is exerted on the threaded joint by means of the drive unit 18. As is known, the torque can be calculated as the product of the force exerted and the length of the effective lever arm. Where a hydraulic cylinder acts as the drive unit 18—to make it easier to read, the following description is continued by taking a hydraulic cylinder as a drive unit 18 as an example but without sacrificing wider applicability—the force is calculated as the product of the pressure exerted by means of the hydraulic fluid drawn from the hydraulic unit 22 (FIG. 6) and the area of the piston by means of which the piston rod 20 is moved. The area subjected to the hydraulic fluid is known and constant. As the illustration in FIG. 5 shows, however, the length of the effective lever arm changes in accordance with the position of the upper tongs 16. The length of the effective lever arm corresponds to the length of a perpendicular through a line connecting a first fixed point 40, at which the hydraulic cylinder 18 is attached pivotably to the lower tongs 14, and a second fixed point 42, at which the piston rod 20 engages on the upper tongs 16.

In this connection, the illustrations in FIG. 5 show snapshots during the rotation of the upper tongs 16 relative to the lower tongs 14, without the clamping blocks 30-36. In this case, the upper illustration shows a position of the upper tongs 16 of about −20° relative to the lower tongs 14, the central illustration shows a position of 0° relative to the lower tongs 14, and the lower illustration shows a position of about +20° relative to the lower tongs 14. The respective lengths of the resulting perpendicular on the line connecting the two fixed points 40, 42 are denoted in the illustrations in FIG. 5 by r1, r2 and r3 (r1>r2; r2>r3). The respective length of the perpendicular corresponds to the respective length of the effective lever arm and it can therefore be seen that the torque that can be applied by means of the hydraulic cylinder 18 at the same hydraulic pressure depends on the extended length of the piston rod 20. Furthermore, this means that, at a constant hydraulic pressure, the maximum torque with which the threaded joint between two drill pipe elements 12 can be tightened by means of a tongs system 10 of the type described here depends on how the upper tongs 16 lie (are rotated) relative to the lower tongs 14 and on how far the piston rod 20 is extended when the threaded joint becomes tight (FIG. 4, right-hand illustration).

For a defined tightening torque, the position of the upper tongs 16 relative to the lower tongs 14 is accordingly detected by means of a displacement measuring system 44 (FIG. 6) included in the tongs system 10 or associated with the tongs system 10, this being achieved in the embodiment shown by detecting the respectively extended length of the piston rod 20 by means of the displacement measuring system 44. In this case, the displacement measuring system 44 can evaluate a solid gauge attached to the piston rod 20 or moved with the piston rod 20—in one embodiment in the form of an incremental encoder or having an incremental encoder, for example. In addition or as an alternative, consideration may also be given to the possibility that the displacement measuring system 44 detects a position of the piston moved in the hydraulic cylinder 18 to retract or extend the piston rod 20, e.g. by way of measuring the flow of the hydraulic fluid introduced for this purpose into the hydraulic cylinder 18 and/or of the hydraulic fluid emerging from the hydraulic cylinder 18. For the sake of greater readability of the description and with a view to as great as possible abstraction in respect of the sensor system on which the displacement measuring system 44 is based and which is fundamentally interchangeable, these possibilities and, where appropriate, further possibilities are summarized below by referring to detection of an extended position of the piston rod 20 or, for short, to a piston rod position 46. The piston rod position 46 is a measure of a position of the upper tongs 16 relative to the lower tongs 14 since the upper tongs 16 are moved relative to the lower tongs 14 by means of the piston rod 20.

At this point, it may be pointed out that the piston rod position 46 can also be determined by calculation if the rotational position of the upper tongs 16 relative to the lower tongs 14 is determined by means of the displacement measuring system 44 and, otherwise, the positions of the fixed points 40, 42 relative to the lower tongs 14 and upper tongs 16 are known. The intention is that such a piston rod position 46 determined by calculation should also be included when reference is made here and below to a position of the upper tongs 16 relative to the lower tongs 14 or to a piston rod position 46 determined by means of a displacement measuring system 44.

By means of a control unit 48 shown in the illustration in FIG. 6, which, as input signals, processes at least the piston rod position 46 as position information that can be obtained from the displacement measuring system 44 (position information relating to the position of the upper tongs 16 relative to the lower tongs 14) and at least one actual pressure value 50, 52 in respect of a pressure prevailing at the hydraulic cylinder 18 (on the piston side and/or the rod side) at a corresponding counterforce, it is thus possible to determine the respective torque (tightening torque) that can be applied for each position of the upper tongs 16 relative to the lower tongs 14 and to compare it with a defined or definable desired tightening torque 54. To determine the tightening torque, the product of the acting force and the effective lever arm is formed by means of the control unit 48. The acting force is determined by means of the control unit 48 as the product of the respective actual pressure value 50, 52 and the area of the hydraulic cylinder 18 acted upon by the pressure. The length of the effective lever arm (see lengths r1, r2 and r3 in the illustration in FIG. 5) is determined by means of the control unit 48, e.g. by means of a table (lookup table), into which the respectively associated and precalculated effective length of the lever arm is entered for a plurality of piston rod positions 46. In the case of piston rod positions 46 that are not included in the table (intermediate values), interpolation is carried out using the values included in the table. As an alternative, the length of the effective lever arm can also be calculated by means of the control unit 48 using the respective piston rod position 46 and the known distance between the two fixed points 40, 42 and the center of the drill pipe elements 12 to be connected. As soon as the torque/tightening torque actually applied by means of the tongs system 10 reaches or exceeds the desired tightening torque 54, the tightening of the thread of the two drill pipe elements 12 is complete.

The control unit 48, which is implemented in the form of a memory-programmable controller or the like, for example, comprises, in a manner known per se, a microprocessor or a comparable functional unit and a memory, for example, into which a control program is loaded, said program being carried out during the operation of the control unit 48 and during the operation of the tongs system 10. Under the control of the control program, connection of a drill pipe element 12 to the drill string takes place on the basis of the measured piston rod position 46 and the desired tightening torque 54, under the following conditions: on the one hand, the tightening torque is limited to the defined desired tightening torque 54. On the other hand, the defined desired tightening torque 54 is reliably achieved.

The activation of the hydraulic cylinder 18 to perform one or more movements of the upper tongs 16 relative to the lower tongs 14, referred to below as strokes, is furthermore also performed under the control of the control unit 48. The upper tongs 16 have a range of movement of −20° to +20° relative to the lower tongs 14, for example, as shown by way of example, but without sacrificing wider applicability, in FIG. 5. A stroke then begins at −20° and ends at +20°. The piston rod position 46 that can be obtained from the displacement measuring system 44 is clearly linked to different rotational positions of the upper tongs 16 relative to the lower tongs 14, i.e. the end position of a stroke at +20° can also be unambiguously and automatically detected by means of the control unit 48 from the piston rod position 46 resulting from this rotational position. Thus, monitoring of the respective instantaneous value of the piston rod position 46 in relation to the piston rod position 46 in the end position of a stroke at +20° is also accomplished by means of the control unit 48. As soon as this piston rod position 46 is detected by means of the control unit 48, a return stroke is automatically performed, i.e. opening of the clamping blocks 34, 36 of the upper tongs 16 and rotation of the upper tongs 16 relative to the lower tongs 14 into the starting position for a new stroke at −20°. The attainment of this starting position can also be detected by means of the control unit 48 from a corresponding piston rod position 46. As soon as the starting position for a new stroke has been reached, the clamping blocks 34, 36 are once again moved in under the control of the control unit 48, and a new stroke begins with appropriate activation of the control block 56 by the control unit 48. This is continued cyclically until - on satisfaction of the two abovementioned conditions—the new drill pipe element 12 has been connected to the drill string. Even if there is no explicit reference to it below, it is understood that, during the connection or release of a drill pipe element 42 to or from the drill string by one or more strokes or one or more return strokes, there is always underlying control and/or monitoring of the individual stroke cycles by means of the control unit 48.

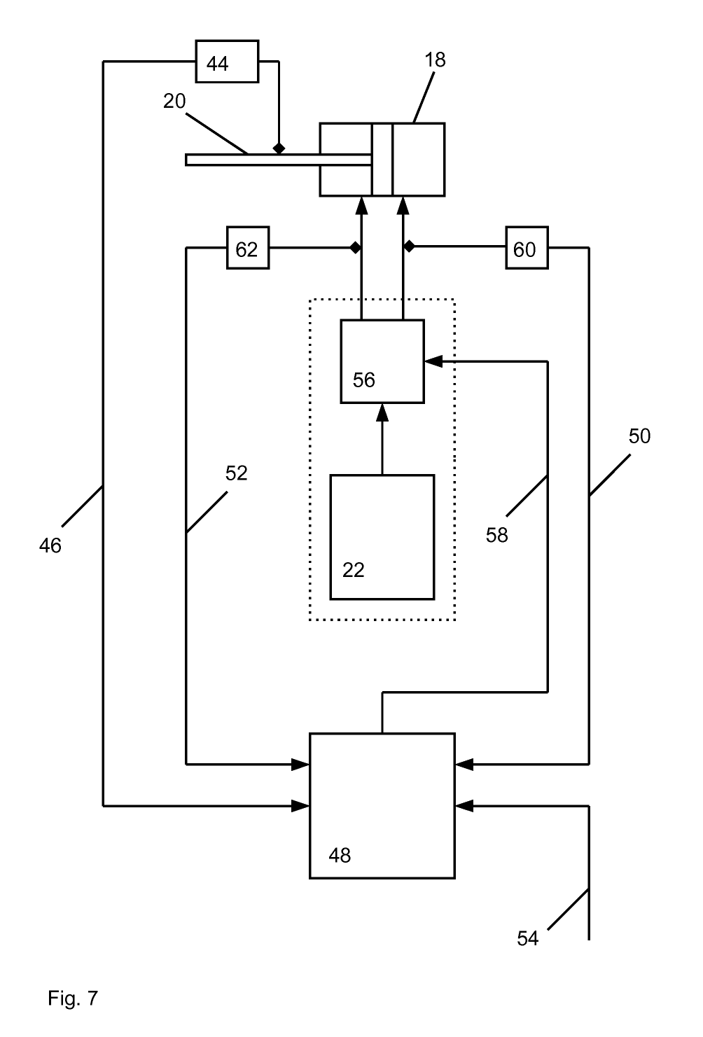

The illustration in FIG. 7 shows, in schematically simplified form, the control unit 48 and the interactions during the pressurization of the hydraulic cylinder 18 to rotate the upper tongs 16 relative to the lower tongs 14 and to screw a drill pipe element 12 to the drill string. Repetition of the illustration of the tongs system 10 has been omitted from the illustration in FIG. 7. To this extent, attention is drawn to the illustration in FIG. 6.

As a measure of the position of the upper tongs 16 relative to the lower tongs 14, the control unit 48 processes the continuously recorded piston rod position 46, or some other measured value describing this position, as well as the desired tightening torque 54. To initiate the rotary movement of the upper tongs 16 relative to the lower tongs 14, the control block 56 is activated with a respective manipulated variable 58. During the forward stroke, i.e. during the connection of a drill pipe element 12 to the drill string, a certain quantity of hydraulic fluid per unit time is pumped into the piston chamber of the hydraulic cylinder 18 (into the annular chamber during the return stroke) in accordance with the activation of the control block 56. When the threaded joint becomes tight during the connection of the drill pipe element 12 to the drill string and, consequently, a countertorque builds up, a noticeable pressure buildup also begins in the piston chamber. The pressure in the piston chamber and in the feed line extending from the control block 56 to the piston chamber is detected by means of a suitable pressure sensor, e.g. a pressure sensor in the form of a pressure cell 60 on the piston chamber side. An actual pressure value 50 that can be obtained from the pressure cell 60 is processed as an input variable by means of the control unit 48. From the piston rod position 46 and the actual pressure value 50 and on the basis of the known and constant size of the piston area, the respectively effective length of the lever arm and the acting forces and hence the torque/tightening torque applied by the tongs system 10 is determined continuously or quasi-continuously, i.e. cyclically at short time intervals, by means of the control unit 48. Thus, the actual pressure value 50 is an example of a measure of a force exerted by a hydraulic cylinder 18 specified for the movement of the upper tongs 16. As soon as the applied tightening torque determined reaches the defined desired tightening torque 54, the connection of the drill pipe element 12 to the drill string while satisfying the two abovementioned conditions (limitation of the tightening torque to the desired tightening torque 54 and guaranteed attainment of the desired tightening torque 54) is complete. The clamping blocks 30-36 of the tongs system 10 can be opened and the tongs system 10 as a whole can be moved into a standby position.

To release a drill pipe element 12 from the drill string, the annular chamber of the hydraulic cylinder 18 is supplied with hydraulic fluid. As an option, a pressure which builds up during the release of the threaded joint is detected by means of a pressure cell 62 on the annular chamber side. By means of the control unit 48, the respectively acting torque is determined (taking into account the smaller annular area in comparison with the piston area) from the piston rod position 46 and from an actual pressure value 52 that can be obtained from the pressure cell 62. The respectively determined torque for separating (“break”) the threaded joint is detected, for example, and logged and/or stored for subsequent statistical evaluations and the like. Furthermore, consideration may also be given to comparing the torque applied for separation with the torque originally applied during the making of the threaded joint (“make”). For this purpose, the torque applied when making the threaded joint and/or the respectively defined desired tightening torque 54 is detected for each tool joint 28 along the drill string, and it is compared in the reverse order when removing the drill string with the torque required to separate the threaded joint. The results that can be obtained in this process can also be logged and/or stored for subsequent statistical evaluations and the like.

When making the threaded joint (“make”), the control block 56 is activated by means of an appropriate manipulated variable 58 at least initially in such a way that a maximum flow rate and hence a maximum speed is obtained for the movement of the upper tongs 16 relative to the lower tongs 14 (high initial speed). By means of the control block 56, a flow rate of the hydraulic fluid passing from the hydraulic unit 22 to the hydraulic cylinder 18 is established. The respective flow rate determines the speed with which the piston rod 20 moves and hence the speed of the movement of the upper tongs 16 relative to the lower tongs 14. As soon as the threaded joint begins to become tight, that is to say, therefore, as soon as a noticeable counterpressure that can be sensed by means of the pressure cell 60 builds up, the speed of the movement of the upper tongs 16 relative to the lower tongs 14 is reduced in comparison with the high initial speed. By means of the control unit 48, a manipulated variable 58 for appropriate activation of the control block 56 is generated for this purpose from the actual pressure value 50 that can be obtained from the pressure cell 60. In principle, different possibilities may be considered for generating the manipulated variable 58.

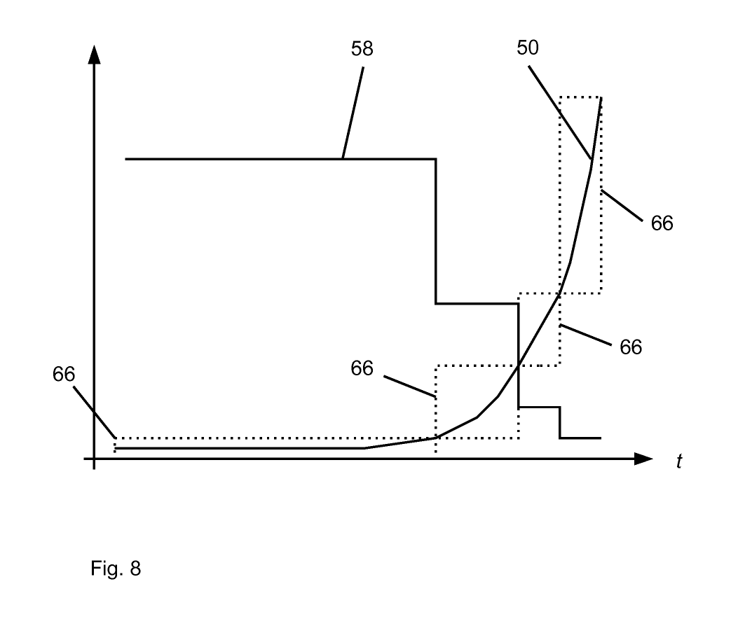

On the one hand, it is possible—as shown in schematically simplified form in FIG. 8—for the expected value range of the actual pressure value 50 to be divided into a number of segments 66, wherein each value range segment 66 is assigned a manipulated variable 58. As the respective actual pressure values 50 included in a value range segment 66 become larger, the value range segment 66 is in each case assigned a manipulated variable 58 which leads to a reduction in the flow rate of the hydraulic fluid passing from the hydraulic unit 22 to the hydraulic cylinder 18 through the control block 56. As a result, each value range segment 66 is assigned a measure of a speed of the movement of the upper tongs 16 relative to the lower tongs 14 and the greater the counterpressure building up becomes—i.e. the tighter the threaded joint becomes—the slower becomes the speed with which the upper tongs 16 are moved relative to the lower tongs 14.

On the other hand, the change in the actual pressure value 50 with respect to time can be taken into consideration and, by means of the control unit 48, a manipulated variable 58 that is inversely proportional, e.g. reciprocal, to the respective change with respect to time can be generated, resulting, in the case of a change in the actual pressure value 50 with respect to time which, at least initially, is negligible or only small, in a manipulated variable 58 on the basis of which the upper tongs 16 are moved with a maximum speed relative to the lower tongs 14. If the change in the actual pressure value 50 with respect to time increases, the result is a manipulated variable 58 on the basis of which the speed of the movement of the upper tongs 16 relative to the lower tongs 14 is continuously reduced.

The two outlined possibilities can also be combined, e.g. in such a way that, in the case of certain value ranges of the actual pressure value 50, a manipulated variable 58 that is linked to the respective value range by a corresponding preset is used while, in other value ranges of the actual pressure value 50, the change thereof with respect to time and a manipulated variable 58 generated on this basis are used.

In a special embodiment of the method, such a combination is taken into consideration in such a way that, during the initial movement of the upper tongs 16 and only a low actual pressure value 50, i.e. a value range starting from a minimum actual pressure value 50 as far as a defined or definable first low actual pressure value 50, a manipulated variable 58 linked to this value range by a corresponding preset is used in order to move the upper tongs 16 as quickly as possible, that, in the case of a value range distributed symmetrically, for example, around the desired tightening torque 54 (desired tightening torque 54±x %), a manipulated variable 58 linked to this value range by a corresponding preset is used in order to move the upper tongs 16 as slowly as possible, and that, between these two value ranges, a manipulated variable 58 generated on the basis of the change in the actual pressure value 50 with respect to time is used.

When releasing the threaded joint (“break”), the control block 56 is activated by means of an appropriate manipulated variable 58 either continuously in such a way that as high as possible a speed of the movement of the upper tongs 16 is obtained. Alternatively, the manipulated variable 58 can also rise in a ramp-like manner—with a defined or definable slope—up to a maximum value, with the result that the initial release of the threaded joint takes place with an initially low but continuously increasing speed and then with as high a speed as possible of the movement of the upper tongs 16.

As an alternative to the previously described method for producing the threaded joint (“make”), one possibility that may be considered is that, from a defined or definable desired tightening torque 54, the control unit 48 is used to automatically determine a manipulated variable 58 which leads to a defined tightening torque corresponding to the desired tightening torque 54. The manipulated variable 58 is used to activate the hydraulic unit 22 or a control block 56 connected downstream of the hydraulic unit 22 and comprising a proportional valve at least for the piston-side port of the hydraulic cylinder 18. By means of the piston rod position 46, which is available as a measured value from the displacement measuring system 44, and the known and constant piston area, it is possible by means of the control unit 48 automatically to determine a pressure required in the respective piston rod position 46 to achieve a tightening torque corresponding to the desired tightening torque 54. A manipulated variable 58 which corresponds to the respectively determined required pressure and is corrected in the event of a change in the piston rod position 46 is transmitted to the hydraulic unit 22 or the control block 56. This ensures that the threaded joint is always tightened to the maximum with the desired tightening torque 54. The release of the threaded joint can be accomplished in a corresponding manner or as described further above.

Here, the end of the process of connecting a drill pipe element 12 to the drill string can be detected automatically by means of the control unit 48 from the fact that the piston rod position 46 no longer changes during a defined or definable time period (because the threaded joint is already tight and the position of the upper tongs 16 relative to the lower tongs 14 is therefore no longer changing). Monitoring of the change in the piston rod position 46 can also be used as an additional abort criterion. In the case of monitoring of the change in the piston rod position 46 as an additional abort criterion, this may be considered as a safety cutout.

To release a drill pipe element 12 from the drill string, one possibility that may be taken into consideration in a special embodiment of the method for operating the tongs system 10 is that, before the closure of the clamping blocks 34, 36, the upper tongs 16 are moved under the control of the control unit 48 and with reference to the piston rod position 46 into a position relative to the lower tongs 14 in which the maximum torque can be applied on the basis of the lever arm which is then effective. A lower hydraulic pressure is then sufficient than if the return stroke for the release of the threaded joint were to begin with a fully extended piston rod 20 and with upper tongs 16 rotated to the maximum relative to the lower tongs 14. As soon as the position of the “favorable lever arm” has been reached under the control of the control unit 48, the clamping blocks 34, 36 are automatically closed and the release of the threaded joint begins through a supply of hydraulic fluid to the annular chamber.

Individual primary aspects of the description presented here may be summarized briefly as follows: the specification relates to a method for operating a tongs system 10 intended for connecting a drill pipe element 12 to an often fixed drill pipe element 12, or for separating a drill pipe element from another drill pipe element 12, which system comprises lower tongs 14 and upper tongs 16 that can be moved relative to the lower tongs 14 by means of a drive unit 18, wherein a position 46 of the upper tongs 16 relative to the lower tongs 14 can be detected, and is detected in operation, by means of a displacement measuring system 44, wherein a tightening torque determined in accordance with the detected position 46 is compared continuously or at regular intervals with a defined or definable desired tightening torque 54 by means of a control unit 48, and wherein the process of connecting the two drill pipe elements 12 is terminated when the determined tightening torque reaches or exceeds the desired tightening torque 54. The specification furthermore relates to a tongs system 10 intended and designed for carrying out the method. As a measure for the position 46 of the upper tongs 16 relative to the lower tongs 14, a piston rod position 46 is detected by means of a displacement measuring system 44, for example. Other measured values may also be considered as a measure for the position 46 of the upper tongs 16. By means of the piston rod position 46 or any other position-specific measured value, the effective length of the lever arm and, on the basis thereof, the respectively acting tightening torque is determined by means of the control unit 48.

List of reference signs

| | |
|---|---|
| 10 | tongs system |
| 12 | drill pipe element |
| 14 | lower tongs |
| 16 | upper tongs |
| 18 | drive unit/hydraulic cylinder |
| 20 | piston rod |
| 22 | hydraulic unit |
| 24 | sleeve/threaded part |
| 26 | threaded spigot/threaded part |
| 28 | tool joint |
| 30-36 | clamping block |
| 38 | drive unit |
| 40 | first fixed point (of the hydraulic cylinder on the lower tongs) |
| 42 | second fixed point (of the hydraulic cylinder on the upper tongs) |
| 44 | displacement measuring system |
| 46 | position of the upper tongs/piston rod position |
| 48 | control unit |
| 50 | (piston-side) actual pressure value |
| 52 | (rod-side) actual pressure value |
| 54 | desired tightening torque |
| 56 | control block |
| 58 | manipulated variable |
| 60 | (piston-side) pressure cell |
| 62 | (rod-side) pressure cell |
| 64 | (free) |
| 66 | value range segment |

1. A method for operating a tongs system (10) intended for connecting a drill pipe element (12) to a fixed drill pipe element (12),
wherein the tongs system (10) comprises lower tongs (14) and upper tongs (16), which can be moved relative to the lower tongs (14) by means of a drive unit (18),
wherein the drive unit (18) is connected non-rotatably on one side to the lower tongs (14) and engages by means of a piston rod (20) on the upper tongs (16) in order to move the latter,
wherein the piston rod (20) is retracted or extended by means of the drive unit (18) in order to change the position (46) of the upper tongs (16) relative to the lower tongs (14), characterized
in that a position (46) of the upper tongs (16) relative to the lower tongs (14) can be detected, and is detected in operation, by means of a displacement measuring system (44),
in that a tightening torque determined in accordance with the detected position (46) is compared continuously or at regular intervals with a defined or definable desired tightening torque (54) by means of a control unit (48),
in that the position (46) of the upper tongs (16) relative to the lower tongs (14) is determined in the form of an extended length of the piston rod (20) detected by means of a displacement measuring system (44), and
in that the process of connecting the two drill pipe elements (12) is terminated when the determined tightening torque reaches or exceeds the desired tightening torque (54).

2. The method as claimed in claim 1, wherein the tightening torque is determined automatically by means of the control unit (48) in accordance with the detected position (46) and in accordance with a measure (50) of a force exerted by a drive unit (18), said measure being recorded in relation to the drive unit (18) specified for moving the upper tongs (16).

3. The method as claimed in claim 2, wherein, in the case of a hydraulic cylinder (18) acting as a drive unit (18), a pressure acting in the hydraulic cylinder (18) during the movement of the upper tongs (16) is detected by means of a pressure sensor (60) assigned to the hydraulic cylinder (18).

4. (canceled)

5. The method as claimed in claim 1,
wherein the upper tongs (16) are moved at an initial speed at the beginning of the connection of the two drill pipe elements (12), and wherein the speed at which the upper tongs (16) are moved is reduced in accordance with a countertorque that builds up during the connection of the two drill pipe elements (12).

6. The method as claimed in claim 4, wherein the pressure acting in the hydraulic cylinder (18) during the movement of the upper tongs (16) is used as a measure for the countertorque that builds up during the connection of the two drill pipe elements (12).

7. The method as claimed in claim 1 and for operating the tongs system (10) in order to release a drill pipe element (12) from a fixed drill pipe element (12),
wherein, with reference to a respective position (46) of the upper tongs (16) relative to the lower tongs (14), said position being detected by the displacement measuring system (44), the upper tongs (16) are moved into a position in which a maximum torque can be exerted before the beginning of release of the connection of the two drill pipe elements (12).

8. A computer program having program code means for carrying out all the steps of claim 1 when the computer program is executed on a control unit (48) for a tongs system (10) intended for connecting a drill pipe element (12) to a fixed drill pipe element (12).

9. A tongs system (10) having means (44, 48, 56, 60) for implementing the method as claimed in claim 1.

10. The tongs system (10) as claimed in claim 9 for connecting a drill pipe element (12) to a fixed drill pipe element (12),
wherein the tongs system (10) comprises lower tongs (14) and upper tongs (16), which can be moved relative to the lower tongs (14) by means of a drive unit (18),
wherein the tongs system (10) comprises a displacement measuring system (44) and a control unit (48),
wherein a position (46) of the upper tongs (16) relative to the lower tongs (14) can be detected by means of the displacement measuring system (44),
wherein a tightening torque acting during the connection of the two drill pipe elements (12) can be determined continuously or at regular intervals by means of the control unit (48) in accordance with the position (46) of the upper tongs (16) relative to the lower tongs (14),
wherein the tightening torque can be compared with a defined or definable desired tightening torque (54) by means of the control unit (48), and
wherein the process of connecting the two drill pipe elements (12) can be terminated by means of the control unit (48) when the determined tightening torque reaches or exceeds the desired tightening torque (54).

11. The tongs system (10) as claimed in claim 9 or 10 and having a control unit (48), into [[the]] a memory of which a computer program having program code means for carrying out said method when the computer program is executed on the control unit (48) for connecting a drill pipe element (12) to a fixed drill pipe element (12) is loaded as a control program.

12. A rig having a tongs system (10) as claimed in claim 9.

13. A rig having a tongs system (10) as claimed in claim 10.

14. A rig having a tongs system (10) as claimed in claim 11.

15. The tongs system (10) as claimed in claim 10 having a control unit (48), into a memory of which a computer program having program code means for carrying out said method when the computer program is executed on the control unit (48) for connecting a drill pipe element (12) to a fixed drill pipe element (12) is loaded as a control program.
